(19) United States
(12) Patent Application Publication
(10) Pub. No.: US 2026/0177226 A1
(43) Pub. Date: Jun. 25, 2026

(54) Swimming pool lighting device

(71) Applicant: Jinhua Gong, Shenzhen (CN)

(72) Inventor: Jinhua Gong, Shenzhen (CN)

(73) Assignee: Jinhua Gong, Shenzhen (CN)

(21) Appl. No.: 19/351,587

(22) Filed: Oct. 7, 2025

(51) Int. Cl. F21V 13/02; F21S 4/20; F21S 9/03; F21S 10/02; F21V 3/06; F21V 23/02; F21V 31/00; F21W 131/401; F21Y 115/10; H05B 45/10; H05B 45/20; H05B 47/155

(52) U.S. Cl. CPC F21V 13/02; F21S 4/20; F21S 9/03; F21S 10/023; F21V 3/062; F21V 23/023; F21V 31/005; H05B 45/10; H05B 45/20; H05B 47/155; F21V 2200/20; F21W 2131/401; F21Y 2115/10

(57) ABSTRACT

This invention discloses a swimming pool lighting device including a waterproof housing with an upper cover plate configured to transmit light. At least one programmable LED strip is disposed on one or more interior surfaces of the housing, and a light guide plate within the housing receives and diffuses light from the LED strip(s) to provide soft, glare-free illumination; when two or more LED strips are present, the LED strips can change color synchronously to create an animated wave-like effect on the light guide plate. An optional rechargeable battery supports off-grid operation and retrofit flexibility. By employing optical diffusion elements and achieving at least an IP68 ingress protection rating, the device delivers energy-efficient, comfortable underwater lighting, reduces pixelation, and improves durability, thereby enhancing safety and visual aesthetics in aquatic environments.

### TECHNICAL FIELD

The present invention relates to the field of swimming pool lighting systems, and more specifically to LED-based underwater lighting apparatuses that provide enhanced visual comfort, uniform illumination, and dynamic color effects. The invention is directed to lighting devices for pools that incorporate advanced optical structures and synchronized, programmable color-changing capabilities to create soft and visually pleasing lighting suitable for aquatic environments.

### BACKGROUND OF THE INVENTION

In recent years, light emitting diode (LED) technology has become the predominant choice for swimming pool illumination, replacing traditional incandescent and halogen lighting fixtures. Despite the advantages of LEDs, such as improved energy efficiency and longer operational lifespans, current LED pool lights exhibit substantial shortcomings that detract from both the aesthetic quality and user comfort of modern aquatic environments.

A common issue with existing LED pool lights arises from their inherently discrete and point-like sources of illumination. This granular structure often results in uneven light distribution, manifesting as visible “spots” or “hotspots” within the pool. Such non-uniformity not only compromises the visual appeal of the illuminated water but also produces a harsh and glaring output that is visually unappealing. Users frequently report that the emitted light is excessively bright and uncomfortable to observe directly, with a distinct lack of softness or diffusion. Prolonged exposure to this kind of lighting can lead to visual discomfort, making these LED solutions especially ill-suited for the sensitive human eye, and ultimately detracting from the intended tranquil and inviting atmosphere of the pool area.

Accordingly, there remains a significant and unmet need for swimming pool lighting systems that improve upon the shortcomings of conventional LED-based solutions by providing enhanced uniformity, softer visual effects, and a more comfortable viewing experience for users.

Another significant drawback associated with current LED technology for swimming pool lighting—whether referencing well-known manufacturers such as Kern or similar brands—is the interaction between LEDs and the underwater environment. LED housings can be prone to leaking if not properly sealed, which is a critical concern given the constant exposure to water and moisture. Water infiltration may lead to premature failure of the LEDs or their internal components, potentially resulting in the need for complete replacement of the light fixture rather than repair. Additionally, the optics of typical Kern LED designs often exacerbate the problem of harsh, concentrated lighting when used underwater, intensifying the “glare effect” and further diminishing visual comfort for pool users. This combination of lower serviceability, vulnerability to water ingress, and uncomfortable glare significantly limits the effectiveness and desirability of currently available LED pool lighting systems.

### SUMMARY OF THE INVENTION

The purpose of the present invention is to provide a swimming pool lighting device that is compact in structure, optically uniform, and highly reliable in waterproof performance, so as to address technical problems of existing LED pool lights including uneven illuminance, strong glare, susceptibility to water ingress, and poor maintainability.

The invention is implemented as follows: a swimming pool lighting device comprising a housing, a cover plate, LED strips, a light guide plate, a battery, and a lamp body, wherein the housing provides a primary load-bearing and protective cavity for the functional components, the cover plate is disposed on an upper side of the housing and serves as a sealed light-transmissive exit window, the LED strips are arranged in pairs on opposed inner sidewalls of the housing, the light guide plate is configured to transmit and diffuse light received from at least one LED strip, the battery is optionally integrated within the lamp body to enable low-voltage and off-grid power supply, and the lamp body provides integrated sealing and structural consolidation of the foregoing components.

Further, the cover plate is arranged relative to the housing so that the primary light emission exits from its underside, thereby expanding pool-wide illumination coverage and significantly reducing direct glare.

Further, the light guide plate is made of a highly transparent material and incorporates optimized surface or internal microstructures (such as dot, line, or micro-prism arrays), with a pattern density that increases progressively in the direction away from the LEDs, so as to achieve luminance uniformity and a non-granular, panel-like emission through internal reflection and refraction.

Further, the light guide plate can be fabricated by screen printing, laser engraving, molding, or micro-prism forming, and a diffuser sheet may be laminated above it to further soften the light, with a preferred diffuser haze of approximately 50% to 80% to balance uniformity and optical efficiency.

Further, the housing is preferably formed of stainless steel, aluminum alloy, or engineering plastics (such as ABS, PC, or PVC) to withstand long-term underwater service and chlorinated environments, with waterproofing achieved by high-quality seals and gaskets, and with an ingress protection rating designed for underwater applications, for example, IP68.

Further, the housing and/or the cover plate may be provided with light-transmitting apertures or aperture arrays for optical and decorative effects, whose positions and quantities can be arranged on the front, sides, or bottom according to application needs to realize customized distributions for directional or ambient illumination.

Further, the LED strips may be single-color or RGB multi-color and support programmable control to realize synchronized color changes, gradations, or dynamic scenes, compatible with smart control systems such as wireless remotes, app-based interfaces, or DMX controllers to achieve coordinated underwater color effects.

Further, the battery solution supports safe low-voltage operation at 12 V or 24 V and facilitates portability, retrofit, or temporary deployment, and may cooperate with USB or solar interfaces to achieve flexible charging; for fixed wired installations, 120 V AC or a 12 V transformer may be employed, with all wiring routed through waterproof conduits to a junction box equipped with GFCI (ground fault circuit interrupter) protection to enhance electrical safety.

Further, the lamp body integrates the cover plate, housing, LED strips, light guide plate, and battery, together with structural and electrical elements, in a modular and unified assembly to improve assembly robustness, sealing reliability, and on-site installation and maintenance convenience.

Compared with the prior art, the present invention, through the cooperation of multiple LED strips disposed on opposed sidewalls and the centrally located light guide plate, achieves a conversion from point-source emission to uniform panel emission, significantly eliminating hotspots, graininess, and harsh glare to enhance underwater visual comfort and visual quality.

Compared with the prior art, the present invention optimizes light-emission directionality (with the underside of the cover plate serving as the primary exit) together with optional light-transmitting apertures for spatial light distribution, balancing wide-area coverage with local guidance, reducing direct-view glare risks, and improving scenario adaptability.

Compared with the prior art, the present invention employs corrosion-resistant and high-strength materials, together with sealing components and potting or analogous processes, to realize the high-level protective reliability required for long-term underwater operation, while achieving up to about 80% energy savings relative to traditional incandescent or halogen solutions, extending service life, and supporting intelligent, customizable control to reduce long-term operation and maintenance costs.

### BRIEF DESCRIPTION OF DRAWINGS

To illustrate the technical solutions of the embodiments more clearly, the accompanying drawings used in the description of the embodiments are briefly introduced below. In the following description, identical reference numerals denote identical components. It is understood that the drawings described below are only some embodiments of the present application, and other drawings may be obtained by those of ordinary skill in the art without inventive effort.

FIG. 1 is an exploded structural schematic view of the swimming pool lighting device of the present disclosure;

FIG. 2 is a front view of the swimming pool lighting device of the present disclosure;

FIG. 3 is a sectional view of the swimming pool lighting device of the present disclosure;

FIG. 4 is an A-A sectional view taken from FIG. 3;

FIG. 5 is a B-B sectional view taken from FIG. 3; and

FIG. 6 is a C-directional view taken from FIG. 3.

FIG. 7 Lithium-battery charging/protection and power-management circuit schematic (including charging indicator).

Reference Numerals: Cover plate (001); Housing (002); LED strips (003); Light guide plate (004); Battery (005); Lamp body (006).

### DETAILED DESCRIPTION OF THE INVENTION

As used herein, the terms “comprises,” “comprising,” “includes,” “including,” “has,” “having,” or any other variation thereof are intended to cover a non-exclusive inclusion. For example, a process, method, article, or apparatus that comprises a list of elements is not necessarily limited to only those elements but may include other elements not expressly listed or inherent to such process, method, article, or apparatus. Furthermore, the use of the indefinite articles “a” or “at least one” to describe elements and components herein is employed merely for convenience and to give a general sense of the scope of the invention. This description should be read to include “one” or “at least one,” and unless it is obvious that it is meant otherwise, the singular also includes the plural.

Certain exemplary embodiments of the present invention are described herein and are illustrated in the accompanying figures. The described embodiments are provided only for purposes of illustrating the present invention and should not be interpreted as limiting the scope of the invention. Other embodiments, modifications, combinations, and improvements of the embodiments described herein will occur to those skilled in the art, and all such alternate embodiments, combinations, modifications, and improvements are within the scope of the present invention.

While the making and use of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

To facilitate understanding of the embodiments described herein, a number of terms are defined below. The terms defined herein have the meanings as commonly understood by those of ordinary skill in the art relevant to the present invention. Terms such as “a,” “at least one,” and “the” are not intended to refer only to a singular entity, but rather include the general class of which a specific example may be used for illustration. The terminology is used to describe specific embodiments of the invention, but their usage does not limit the invention, except as set forth in the claims.

The phrase “in one embodiment,” as used herein, does not necessarily refer to the same embodiment, though it may do so. Conditional language used herein, such as “can,” “might,” “may,” “for example,” and the like, unless specifically stated otherwise or as otherwise understood within the context as used, is generally intended to convey that certain embodiments include, while other embodiments do not include, certain features, elements, and/or states. Thus, such conditional language is not generally intended to imply that features, elements, and/or states are required for one or more embodiments, or that one or more embodiments must include logic for deciding whether such features, elements, and/or states are included or are to be performed in any particular embodiment, regardless of whether such logic is operable, implemented, or otherwise.

The technical solutions of the exemplary embodiments of the present application are described clearly and completely below in conjunction with the figures of the present application. It is apparent that the described embodiments are only a part of the embodiments of the present application and not all possible embodiments. All other embodiments obtained by those skilled in the art based on the disclosed embodiments without creative efforts shall fall within the scope of the protection of the present application.

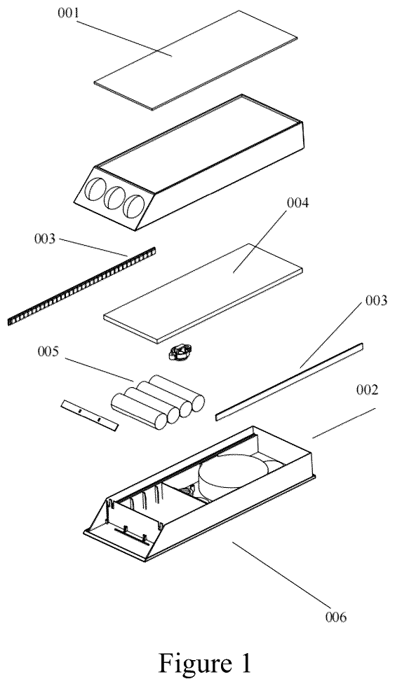

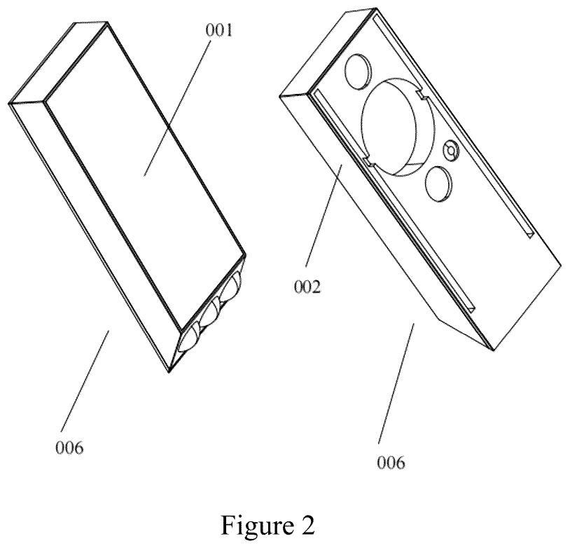

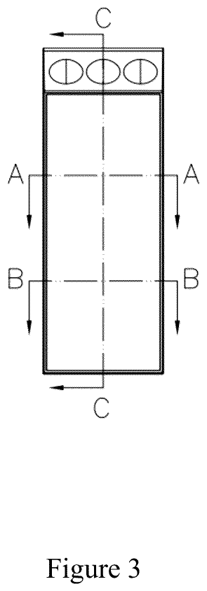

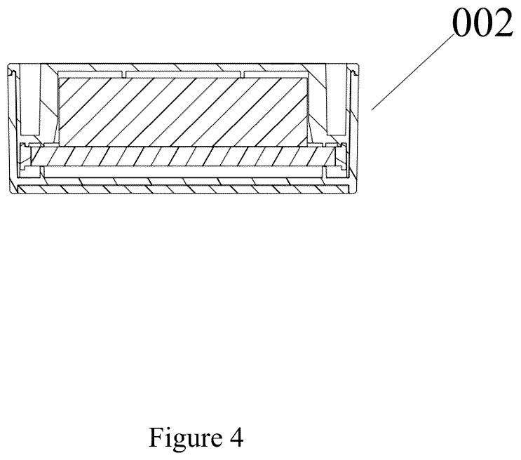

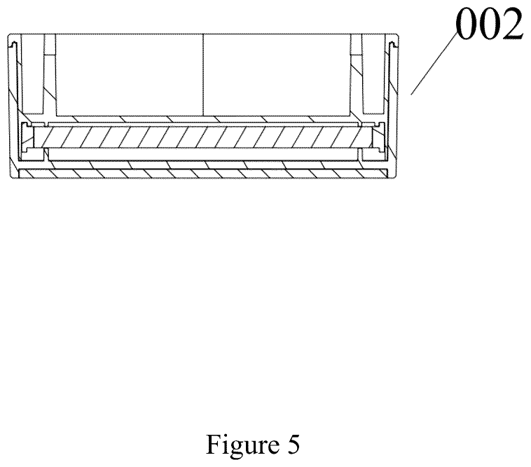

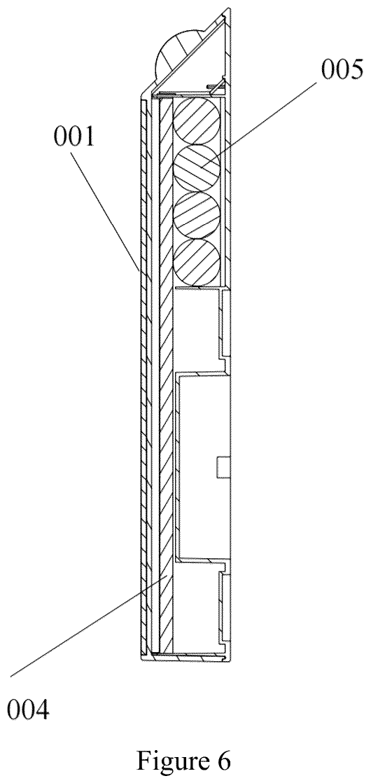

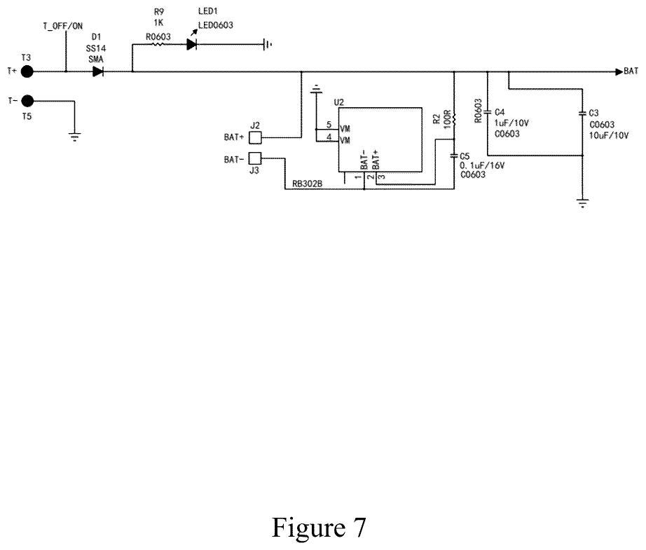

As shown in FIGS. 1-7, in a particular embodiment, invention relates to a highly efficient and visually comfortable LED pool lighting device, comprising a housing (002) that forms the primary enclosure for all functional elements. Positioned in parallel along both inner sides of the housing (002) are two or more LED strips (003). Located between these LED strips (003) is a specially designed light guide plate (004), which receives light from the LEDs (003) and emits a soft, diffused glow. This configuration eliminates visible pixellation and harshness, thus providing a soothing visual effect that substantially overcomes the drawbacks of prior art LED pool lights, where direct-view LEDs often create uncomfortable granular lighting.

Covering the upper side of the housing (002) is a cover plate (001), configured to allow illumination to exit primarily from beneath. This directional control not only improves the uniformity of lighting but also reduces glare, further enhancing swimmer comfort and safety. In preferred embodiments, the device incorporates an internal battery (005), enabling off-grid installation and easy maintenance, and making the assembly portable or suitable for retrofit applications when external wiring is undesirable.

The lamp body (006) integrates the cover plate (001), housing (002), LED strips (003), light guide plate (004), and battery (005) into a unified structure engineered to withstand underwater conditions and deliver optimal light performance. Compared to conventional incandescent or halogen pool lights, the disclosed invention offers up to 80% reduction in energy consumption, extended operational lifespan, and improved customization, while supporting modern smart control functions and reducing long-term operational costs.

By employing advanced arrangements of LED strips (003) in combination with a high-quality light guide plate (004) within a robust housing (002) and a cover plate (001), optionally powered by a battery (005), this invention provides both exceptional visual experience and superior durability for modern aquatic lighting needs, with all essential elements efficiently integrated in the lamp body (006).

In one embodiment, in aquatic environments such as swimming pools and hot tubs, lighting plays a critical role not only in visibility but also in comfort and ambiance. Conventional LED sources, while energy-efficient, often emit harsh, high-intensity light with pronounced granularity, which can result in visual discomfort and glare—particularly in low-reflective water surfaces. Prolonged exposure to such direct lighting may contribute to ocular strain, photophobia, and long-term retinal stress, especially in leisure settings where users are frequently gazing toward illuminated surfaces.

According to one embodiment, by integrating a precision-engineered light guide plate (LGP) between LED emitters, the luminous output is transformed into a uniformly diffused, soft beam profile. This optical modulation significantly reduces point-source intensity and eliminates hotspots, creating a visually soothing environment that is far more conducive to relaxation and social interaction. Whether during nighttime swimming or gatherings around a hot tub, the use of a high-performance LGP ensures that the lighting remains gentle on the eyes, aesthetically pleasing, and functionally safe—making it an ideal solution for premium underwater and poolside illumination systems.

According to another aspect, the present invention provides a swimming pool lighting apparatus engineered to deliver exceptionally soft and uniform illumination, overcoming the pronounced drawbacks associated with conventional LED pool lights. Existing pool lighting solutions typically employ direct-lit LEDs, which, in the absence of a dedicated light guide structure, produce harsh, pixelated, and visually uncomfortable effects that can be distracting and even hazardous to swimmers' comfort.

The disclosed apparatus comprises a housing (002) that serves as the primary support and protective enclosure for internal components. The uppermost portion of the housing (002) is covered by a cover plate (001), which functions not only as a barrier against environmental ingress but also as an optical exit window. The cover plate (001) is designed so that the majority of light emission is directed downward through its underside, optimizing pool-wide illumination and minimizing glare.

In a further embodiment, arranged within the housing (002) along opposing sides are two or more LED strips (003), which may consist of linear, curved, or other appropriately configured arrangements to provide broad luminous coverage. Crucially, at the central axis of the housing (002)—between the LED strips (003)—there is provided a light guide plate (004). The light guide plate (004) accepts light from the LED strips (003), performing both diffusion and homogenization functions, whereby the emitted light appears smooth, consistent, and free of the granular texture that typically afflicts conventional LED designs. This structural improvement ensures an ambient lighting effect that is easy on the human eye, providing a visually relaxing environment suitable for both recreational and professional aquatic settings.

To further enhance optical performance, the housing (002) may include additional light-transmitting apertures around its periphery. These apertures are strategically placed to improve overall illumination coverage and avoid localized shadowing. Beneath the primary lighting chamber, the apparatus may comprise a battery (005), enabling flexibility for installation where direct-wired power infrastructure is not conveniently available. The integration of the battery (005) also opens avenues for portable, low-voltage, or retrofittable lighting deployments—advantages well recognized in recent pool lighting patents.

In some embodiments, all aforementioned structural and functional elements—the cover plate (001), housing (002), LED strips (003), light guide plate (004), and battery (005)—are integrated into a unified lamp body (006). The lamp body (006) is engineered for durability in wet and submerged environments, meeting or exceeding standards for ingress protection and candidate pool safety regulations.

This novel architecture achieves the essential goals of maximizing visual comfort, minimizing energy consumption, and greatly prolonging device service life by leveraging the inherent advantages of LED technology in conjunction with state-of-the-art optical diffusion methods.

In an alternative configuration, the disclosed lighting device consists of a housing (002), which serves as the main enclosure and is engineered for watertight integrity. State-of-the-art waterproofing techniques may be employed, such as high-quality seals, gaskets made of silicone or similar elastomers, and the use of corrosion-resistant materials for all exposed structural parts. The housing (002) is designed with ingress protection (such as IP68) to ensure reliable and prolonged underwater operation.

Located at the top of the housing (002) is a cover plate (001). The cover plate (001) may be fabricated from a variety of light-transmissive materials, including but not limited to tempered glass, polycarbonate, acrylic (PMMA), or specialty plastics engineered for optical clarity and impact resistance. The choice of cover plate (001) material ensures both functional light emission and physical protection of internal components. The cover plate (001) is sealed to the housing (002) in a manner that prevents water ingress, and it is positioned so that the majority of light escapes from below, maximizing illuminated area while minimizing glare.

Within the interior of the housing (002), two or more LED strips (003) are mounted on opposite inner sides. These LED strips (003) are arranged to direct light laterally toward a centrally positioned light guide plate (004). The light guide plate (004) is a critical optical component, fabricated from highly transparent material with engineered surface features or diffusive treatments. It receives light from the LED strips (003) and redistributes it, creating a uniform, soft, and non-granular luminous effect that is visually comfortable even during prolonged underwater exposure.

The housing (002) may include additional light-transmitting apertures to broaden and enhance the spread of illumination throughout the pool. Beneath or within the housing (002), a battery (005) may be integrated to provide power in off-grid or retrofittable installations, thereby increasing installation versatility and safety by enabling low-voltage operation.

All of the essential structural and electrical components—including the cover plate (001), housing (002), LED strips (003), light guide plate (004), battery (005), and associated waterproofing measures—are integrated to form a cohesive lamp body (006). The lamp body (006) is constructed to withstand both the chemical environment of pools and the challenges of long-term wet immersion, providing enhanced safety, superior optical performance, and ease of installation or replacement.

In additional embodiments, provides a versatile and aesthetically advanced swimming pool lighting apparatus designed for both high waterproof reliability and visual appeal. At the core of the invention is a housing (002), which serves as the main enclosure for all functional and optical components. The housing (002) is sealed by a cover plate (001) positioned at the uppermost part of the assembly, which both protects the internal elements and provides a well-defined optical window for light output. The cover plate (001) can be fabricated from light-transmissive materials such as tempered glass, polycarbonate, acrylic, or specialized transparent plastics, offering excellent impact resistance and clarity suitable for underwater environments.

Within the housing (002), multiple LED strips (003) are strategically arranged, typically along the lateral sides or around the perimeter. Centrally disposed among the LED strips (003) is a light guide plate (004), which functions as the primary optical diffusing element. The light guide plate (004) is constructed from highly transparent material with microstructural features engineered to evenly disperse light, converting direct light from the LED strips (003) into a gentle, uniform glow that greatly reduces pixelation and harsh glare.

The design of the housing (002) is modular and adaptable, featuring a variety of possible shapes such as round, rectangular, oval, or custom geometries to suit different installation requirements and pool aesthetics. The housing (002) is further enhanced with one or more apertures or holes, which may be positioned variably to modulate the direction and distribution of light as well as to add decorative elements. For applications requiring frontal illumination, apertures can be formed on the front side of the housing (002), whereas other designs may utilize side or bottom openings. The position and number of these holes are selected based on the specific application, achieving a harmonious blend of form and function.

The preferred construction materials for the housing (002) and the overall lamp body (006) include engineering plastics such as ABS, polycarbonate, and PVC, as well as metals like stainless steel and aluminum—materials commonly employed in current swimming pool lighting for their superior chemical resistance, strength, and waterproofing performance. Modern pool lights frequently use such robust casings to withstand chlorine, UV exposure, and the rigor of aquatic installation.

A battery (005) may be integrated within the housing (002) or lamp body (006) for portable or off-grid installations. All components—the cover plate (001), housing (002), LED strips (003), light guide plate (004), battery (005), and any necessary sealing elements—are assembled to form a cohesive lamp body (006) tailored for reliable, durable, and visually appealing subaqueous lighting.

In other embodiments, discloses a swimming pool lighting apparatus that incorporates advanced optical and structural technologies to provide superior luminous uniformity, safety, and durability. The lighting apparatus comprises a housing (002) that acts as the primary enclosure for all internal elements. Mounted at the upper region of the housing (002) is a cover plate (001), fabricated from optically transparent and impact-resistant materials such as polycarbonate, tempered glass, or acrylic. The cover plate (001) ensures efficient light transmission while protecting the internal components from the aquatic environment and mechanical impact.

Inside the housing (002), at least two LED strips (003) are arranged parallel to each other. Positioned centrally between these LED strips (003) is a light guide plate (004). The light guide plate (004) plays a crucial role in achieving a glare-free, evenly distributed, and visually comfortable illumination. This is accomplished through patterned optical structures—such as dots, lines, or micro-prisms—on or inside the light guide plate (004), which internally reflect and refract light from the LED strips (003) to uniformly distribute it across the emitting surface. The pattern density and geometry are optimized: sparser near the LEDs (003) and denser farther away, thus leveling the output brightness.

Light guide plates (004) can be produced by several methods:

Silk-printed LGPs utilizing screen-printed dot patterns for maximum uniformity;

Laser-engraved LGPs for cost-effective and custom optical patterns;

Molded LGPs for mass production at lower cost, suitable for robust applications;

Micro-prism LGPs offering precise light control for demanding illumination environments.

These plates (004) are typically constructed from high-quality transparent plastics—most commonly acrylic or polycarbonate—with thicknesses ranging from 2 mm to 8 mm, as thicker plates improve light distribution and long-term stability. For enhanced softness, a diffuser sheet may be layered atop the light guide plate (004), further reducing glare and improving eye comfort; optimal diffuser haze is 50-80% depending on application needs.

To accommodate various installation scenarios and pool aesthetics, the housing (002) and lamp body (006) may be configured in multiple shapes (round, square, or custom forms) and fabricated from industry-standard materials such as engineering plastics or corrosion-resistant metals. Additional apertures in the housing (002) can be provided for aesthetic or functional customization—these may be located at different positions depending on the specific lighting requirements (e.g., frontal, side, or bottom emission).

Power to the lighting apparatus can be supplied by an integrated battery (005) enclosed within the lamp body (006), enhancing safety, reducing installation complexity, and enabling compatibility with both retrofittable and portable pool lighting systems. The final lamp body (006) is constructed as a waterproof, chemically-resistant assembly integrating all aforementioned components—cover plate (001), housing (002), LED strips (003), light guide plate (004), and battery (005)—to form a versatile, long-lived, and visually optimal illumination solution for swimming pools and similar aquatic installations.

Optionally, invention relates to an advanced swimming pool lighting system comprising carefully engineered components designed for optimal safety, versatility, and lighting performance. The core structure includes a robust housing (002), which can be formed in various shapes (e.g., round, rectangular, custom geometries) from materials such as stainless steel, resin, or engineering plastic to maximize both corrosion resistance and waterproof characteristics essential for aquatic applications. The housing (002) is constructed to meet or exceed an IP68 rating, ensuring reliable long-term underwater performance and protecting internal electrical components from moisture damage.

Affixed to the upper portion of the housing (002) is a cover plate (001). The cover plate (001) serves as a sealed, light-transmissive interface that ensures both light output and pressure resistance. It may be manufactured from materials such as tempered glass, polycarbonate, or acrylic, chosen for their strength, clarity, and compatibility with underwater environments.

Within the housing (002), a plurality of LED strips (003) are mounted along the internal framework. LED strips (003), which may feature single-color or RGB multi-color functionality, are selected for their flexibility and ability to provide accent, ambient, or dynamic lighting effects. These LEDs (003) are arranged to maximize luminous coverage and can support a wide range of lighting schemes including outlining shapes, illuminating pool steps, and producing customizable color scenes. Waterproof LED strips (003) may be surface-mounted or embedded as required by the application.

Positioned centrally among the LED strips (003) is a light guide plate (004). The light guide plate (004), fabricated from high-quality acrylic or polycarbonate, employs advanced patterning (such as silk-printed, laser-engraved, or molded micro-prisms) to evenly distribute light received from the LED strips (003) across the emission surface. This results in a smooth, glare-free, and visually comfortable illumination ideal for underwater settings. In some embodiments, a diffuser layer may be incorporated above the light guide plate (004) to further soften the light and ensure uniformity.

The lamp body (006) also accommodates additional features such as integrated apertures or decorative openings in the housing (002) and/or cover plate (001), enabling custom light patterns and contributing to the device's aesthetic appeal. These apertures may be located on various surfaces depending on user requirements—front, sides, or bottom—for targeted or accent lighting.

A battery (005) may be included within the housing (002) or as part of the lamp body (006), permitting cordless installation and safe low-voltage operation (typically 12V or 24V). This configuration enables compatibility with smart control systems, including wireless remotes, app-based interfaces, or DMX controllers for dynamic lighting effects.

In summary, the disclosed lighting apparatus combines a waterproof housing (002), a sealed and optically optimized cover plate (001), versatile LED strips (003), an advanced light guide plate (004), optional battery (005), and an integrated lamp body (006). This system achieves durable, safe, and visually pleasing illumination uniquely suited to modern swimming pool environments—whether installed underwater, surface-mounted, or deployed as temporary floating light solutions.

The invention relates to a versatile swimming pool lighting apparatus that can be adapted for both hardwired and battery-powered installations, while ensuring superior waterproofing, user safety, and high-quality illumination. The core component is the housing (002), designed to securely contain all internal modules and fabricated from corrosion-resistant materials such as stainless steel, engineering plastics, or resin, to withstand prolonged immersion and exposure to pool chemicals. The housing (002) may assume various forms for aesthetic or functional requirements and serves as the structural backbone of the lamp body (006).

Affixed to the housing (002) is a cover plate (001), which acts as an optically clear, impact-resistant barrier. The cover plate (001) may be manufactured from tempered glass, polycarbonate, or acrylic to ensure optical transparency and physical durability. The interface between the cover plate (001) and housing (002) is sealed to achieve at least an IP68 waterproof rating, which is essential for reliable underwater operation and protection of all electrical and optical components.

Within the housing (002), multiple LED strips (003) are arranged to provide uniform and customizable illumination. These LED strips (003) may be tailored for specific lighting effects, including single-color, RGB, or dynamically controllable configurations through smart control systems. For wired installations—typical in in-ground pools—the lighting apparatus is connected to the main power supply, operating either on 120V AC or via a 12V transformer for enhanced safety and energy efficiency. All wiring passes through waterproof conduits entering the housing (002) and is connected to a junction box with GFCI (ground fault circuit interrupter) protection to maximize electrical safety.

Alternatively, for above-ground or temporary installations, the invention may incorporate a rechargeable battery (005) within the lamp body (006). The battery (005) allows for cordless, portable operation, with charging provided via USB or solar interface, as suitable. Battery-powered models typically offer up to 12 hours of continuous illumination, depending on features such as color-changing modes.

A central feature between the LED strips (003) is the light guide plate (004), which receives and diffuses light, ensuring a soft, even, and glare-free emission across the pool. The light guide plate (004) is crafted from high-transparency acrylic or polycarbonate and may be supplemented by a diffuser sheet for further visual comfort.

Whether deployed as a permanent wired fixture or a rechargeable, portable option, all embodiments consolidate the cover plate (001), housing (002), LED strips (003), light guide plate (004), and battery (005) into a robust and modular lamp body (006). The system's design fully complies with modern safety and waterproofing standards and may be expanded with smart control features for user-friendly and dynamic poolside ambiance.

Alternatively, invention discloses a swimming pool lighting apparatus equipped with a dynamic color-changing feature and synchronized illumination effects for enhanced ambiance and user experience. The lighting system comprises a housing (002), which incorporates an optically clear cover plate (001) at its upper region for reliable light transmission and protection from the aquatic environment.

Within the housing (002), multiple LED strips (003) are installed along opposed internal surfaces. These LED strips (003) are programmable and capable of changing colors in a coordinated fashion, creating animated, flowing effects reminiscent of moving waves. Advanced circuitry or controllers enable all LED strips (003) to display identical colors at corresponding points in time—when the left side LED strip (003) is emitting a red light, the right side LED strip (003) is also emitting a synchronous red light, ensuring symmetrical and harmonious visual presentation throughout the device.

Centrally positioned between the LED strips (003) is a precisely engineered light guide plate (004). The light guide plate (004) collects and redistributes light emitted from both LED strips (003), leveraging a pattern of optical dots, lines, or microstructures to reflect and refract light internally. This unique structure achieves a soft, glare-free illumination that is visually comfortable, while also intensifying the “wave” effect when the LEDs (003) transition through their color sequences. Reflected light from the light guide plate (004) interacts with the cover plate (001), further smoothing and broadening the visible emission in the pool environment.

The lighting device's dynamic color effects may be realized using DMX controllers, microprocessor control, or other intelligent synchronization means previously used in advanced LED pool lights. Such systems typically allow for both user-programmable and automatic color cycling, supporting fixed, graduated, or random sequences and facilitating “color wave” effects that travel through the water or reflect off other surfaces.

All components—including the cover plate (001), housing (002), LED strips (003), light guide plate (004), and any integrated battery or power supply—are assembled to form a water-tight lamp body (006) engineered for extended underwater operation and superior reliability. This construction allows the invention to deliver dynamic, synchronized, and visually pleasing illumination effects not achievable with conventional pool lighting systems, thus providing substantial advantages for modern aquatic installations.

Another embodiment the device may include one or more electronic modules, sealed within the housing or lamp body, to monitor battery status, provide signal reception (such as for wireless remotes or infrared control), and facilitate mode switching via waterproof external buttons. Suitable interface components—such as main control circuits, indicator LEDs, and receiver modules—may be mounted on internal support structures, while being externally accessible through transparent or sealed portions of the housing. This arrangement allows for clear visual indication of operational states (such as battery charge, color mode, or connection status) without compromising the integrity of the housing or risking water ingress.

To further enhance ease of use and installation versatility in aquatic environments, the lighting apparatus may provide reinforced structural features such as detachable or hinged mounting brackets, sealing gaskets, or soft rubber plugs for external power or signal ports. Where charging or external power access is required (such as with replaceable batteries or connector sockets for remote charging), flexible plugs or gasket covers may be employed to reliably seal any openings when not in use. Such robust enclosure and interconnection means, based on principles proven in outdoor and string light applications, ensure that the swimming pool lighting system maintains high ingress protection and user safety while allowing for modular upgrades, repairs, or feature customization.

In the foregoing embodiments, descriptions of each embodiment are emphasized differently, and parts not detailed in one embodiment can be referred to in the descriptions of other embodiments.

It should be noted that all directional indications (such as upper, lower, left, right, front, rear, etc.) described in the embodiments of this invention serve only to illustrate the relative positional relationships and movement between respective components in a given posture. If the specific posture changes, then such directional indications should be changed accordingly.

It is further to be noted that when an element is referred to as being “fixed to” or “disposed on” another element, it may be directly on that other element or may also be present with intermediate elements therebetween. When an element is referred to as being “connected” to another element, it may be directly connected or indirectly connected via one or more intermediate elements.

The above description relates only to the preferred embodiments of the present invention and should not be construed as limiting the scope of the claimed invention. Any equivalent structural modification or transformation utilizing the invention's teachings and drawings, whether applied directly or indirectly to other related technical fields, shall be deemed to fall within the scope of protection of the present invention.

1. A swimming pool lighting device comprising:
a housing having a cover plate on an upper side, the cover plate being configured to transmit light;
at least one LED strip disposed within the housing on one or more interior surfaces of the housing;
a light guide plate disposed within the housing and configured to transmit and diffuse light received from the at least one LED strip and to emit, through at least a portion of the housing, a soft and glare-free illumination;
wherein the housing includes one or more apertures configured to emit light outward;
wherein the at least one LED strip is configured to change color and to generate, on the light guide plate, an animated wave-like lighting effect; and
wherein, when two or more LED strips are present, the LED strips are disposed on opposing interior surfaces, the LED strips are configured to change color synchronously to display identical colors at corresponding times, and the light guide plate is positioned between the LED strips.

2. The device of claim 1, wherein the at least one LED strip is capable of emitting red, green, blue, and combinations thereof; and when two or more LED strips are present, colors of LED strips disposed in opposition change synchronously so as to display identical colors at the same time.

3. The device of claim 1, wherein the wave-like lighting effect is achieved by programming the at least one LED strip to vary output intensity and color sequentially along its length.

4. The device of claim 1, wherein the light guide plate includes optical dot, line, or micro-structure patterns configured to enhance light uniformity and diffusion through internal reflection and refraction.

5. The device of claim 1, wherein the cover plate is fixed to the housing, and the cover plate reflects or transmits light from the light guide plate outward so that the wave-like lighting effect is visible in a pool environment.

6. The device of claim 1, wherein the light guide plate is made of transparent acrylic, polycarbonate, or similar optical plastic, and has a thickness of 2 mm to 8 mm.

7. The device of claim 1, wherein the housing is constructed to achieve at least an IP68 ingress protection rating to provide fully submersible waterproof performance.

8. The device of claim 1, further comprising a battery disposed within the housing or the lamp body to provide a rechargeable or portable power supply for the at least one LED strip.

9. The device of claim 1, further comprising a diffuser sheet disposed adjacent to the light guide plate to further soften illumination.

10. The device of claim 1, wherein an intelligent controller is configured to control and synchronize color changes of the at least one LED strip and the wave-like lighting effect; and when two or more LED strips are present, the intelligent controller is configured to cause colors of multiple LED strips to change synchronously, and optionally to provide wireless remote control or app-based programming to achieve customizable ambiance.
